(19) United States
(12) Patent Application Publication
(10) Pub. No.: US 2012/0221433 A1
(43) Pub. Date: Aug. 30, 2012

(54) 3D Click to Buy

(76) Inventors: Joseph Anthony Plattsmier, Austin, TX (US); Lee Martin Stewart, Austin, TX (US)

(21) Appl. No.: 13/219,294

(22) Filed: Aug. 26, 2011

Related U.S. Application Data
(60) Provisional application No. 61/379,341, filed on Sep. 1, 2010.

(51) Int. Cl. G06Q 30/06; G06T 17/00

(52) U.S. Cl. 705/26.8; 345/419

(57) ABSTRACT

An e-commerce method, comprising: providing a plurality of interactive 3D models in a data storage device, at least one said 3D model for each of a plurality of products. The 3D models including parametric data for rendering a 3D image of a selected product; providing Rendering Engine software receiving parametric data from the 3D models and rendering a 3D image on a display on a client side workstation. The Rendering Engine software executing on a client side or a server side workstation. The user specifies search criteria for searching for a selected product whose 3D model is stored on the data storage device. The search software returns a list of products matching the search criteria and prompts the user to select one said product. The Rendering Engine renders a 3D image of the product using the 3D model, and prompts the user to interact with the 3D model.

### RELATED APPLICATIONS AND CLAIM FOR PRIORITY

The present application is related to and claims priority from U.S. Provisional Patent Application Ser. No. 61/379,341 filed Sep. 3, 2010 which is incorporated herein by reference thereto.

### FIELD OF THE INVENTION

The present invention relates generally to a system, process and software for facilitating commerce and electronic commerce (e-commerce) transactions, and more specifically to a system, process and software to allow the purchase of products and parts from or within 3D models.

### BACKGROUND OF THE INVENTION

Three-dimensional (3D) models are methods of rendering and manipulating a graphical object or hologram. It should be understood that the system, process and software of the present invention may be used with a model capable of rendering either a 3D image on a display screen or a 3D hologram. As used throughout this specification, the term 3D image should be understood to include imaging systems (a camera, an eye, stereogram or hologram) having 3 dimensions (x, y, z coordinates or having volume).

Within the context of electronic commerce (hereinafter “ecommerce”), 3D models are useful for displaying real tangible products and concept products on a computer as a 3D model. Importantly, 3D models enable a user to interact with the graphical rendering or image. The 3D image can be rotated about an axis, exploded, decomposed or adjusted visually or parametrically in levels of detail view to fully understand and visualize the item or product at a virtual level. This flexibility has resulted in creating a high demand for 3D models.

The term “explode” is used to refer to a rendered view of an object in which the discrete or constituent parts are separated from a clearly visible object. A partially decomposed view refers to a view in which some of the parts are removed to reveal hidden parts or assemblies. A fully decomposed view is the same as an exploded view and reveals all the parts which form the part, object or assembly.

### BRIEF DESCRIPTION OF THE INVENTION

The present invention is a system and software that allows a user to interact with a rendered 3D image, part or assembly (defined as any set of N-number of parts, where N>1), select a single part or decompose the 3D assembly to its finite (discrete or constituent) parts, select a specific part or multiple parts and add that part to a commerce or electronic-commerce process (such as an online shopping cart). It should be understood that the term “interact” is intended to encompass manipulating the rendered 3D image through the use of rotating the image about any axis, enlarging or shrinking the image, exploding or decomposing the image in one or more levels of detail to reveal the constituent parts and/or sub-assemblies of the corresponding model. Optionally, interacting with the object may include displaying parametric data, metadata and/or secondary parts associated with a part (or assembly). The term “part” may encompass a discrete part such as a screw or a spring, a group of associated parts (e.g., a kit), or a sub-assembly.

3D images are differentiated from 2D static images (such as a photograph or rasterization graphics) in that displaying for the two types are distinctly accessible through separate processes. 2D parametric images or vector graphics are similar in nature to 3D parametric images with the exception that 2D parametric images either contain a third dimension (coordinate plane of value zero) or the third dimension is omitted. 2D static image processes cannot function within a 3D representation. An image map (which may or may not contain metadata) that is overlaid on a 2D static image will not function with a 3D image when the 3D model is manipulated since the 2D static data lacks a third plane of data or is set to zero. In a similar scenario a 3D image map would contain additional information that could not be viewed or accessed when manipulating the 2D image since the flat nature of the 2D image could not be manipulated in such a way as to reveal the 3D mappings. Systems of this nature implemented in 2D static mappings are cumbersome and can obscure critical information necessary for accurate parts identification and selection processes.

Stated differently, when an image map (internet term: a hypertext markup language tag <map> to define a client side region with clickable areas) is used with a 2D image the metadata is associated with the region and not the image. The problem with this approach is the image map will still be viewable and clickable if the 2D image is not available or has been changed. The relationship must be made between the image map and the 2D static image in the html where as in 3D the metadata is contained in the file format. Although the image map function might still remain intact it may become meaningless or highly confusing if the image cannot be retrieved or if the image map inadvertently is used in conjunction with another 2D image.

An embodiment of the invention is to provide a method of purchasing a part by interacting with a three-dimensional model (3D) or a derivative of the model. The client display system renders the parametric data to view the 3D model and with an action (such as clicking a mouse button or finger tap) the purchaser is able to complete an order, such as adding the part to a shopping cart or other commerce or electronic commerce purchasing application.

Due to the limitations of the patent application process it is not possible to directly show 3D images, therefore all images are 2D and are illustrated from 3D and simulate a 3D view after being manipulated for the purpose of the embodiments.

### SUMMARY OF THE INVENTION

A first embodiment of the invention is an e-commerce method, comprising:

providing a plurality of interactive 3D models in a data storage device, at least one 3D model for each of a plurality of products, the 3D models including parametric data for rendering a 3D image of a selected product;

providing Rendering Engine software receiving parametric data from the 3D models and rendering a 3D image on a display on a client side workstation, the Rendering Engine software executing on one of a client side and a server side workstation;

allowing a user on a client side workstation to search for a selected 3D model among the plurality of 3D models on the data storage device;

rendering a 3D image using the selected the 3D model;

the rendering engine software enabling the user to interact with the 3D model; and

providing ecommerce software communicating with the Rendering Engine software allowing the user to initiate an ecommerce transaction with respect to the parts or subassemblies depicted in the rendered 3D image.

In the aforementioned method, interaction with the 3D model may include the ability to rotate the rendered 3D product image about the X, Y, and Z coordinate axis.

In the aforementioned method, interaction with the 3D model may include the ability to rotate the product image about a user-specified axis.

In the aforementioned method, the interaction with the 3D model may include the ability to decompose the rendered 3D image of the product in one or more stages to reveal hidden parts or subassemblies. In the aforementioned method, selecting or hovering over a rendered 3D image with a pointer of a pointing device triggers the Rendering Engine software to display metadata associated with the part.

Moreover, selection of a portion of the rendered 3D image triggers the rendering engine to highlight the selected portion of the image. Still further, additional parts (i.e., parts other than those already selected) related to the selected part are highlighted and the user is prompted to add the additional parts to an ecommerce shopping cart or virtual shopping cart.

According to one aspect of the invention, if the selected part is available as part of a kit including additional parts then the additional parts are graphically displayed to indicate the availability of a kit and the user is prompted to add the kit to the ecommerce shopping cart or virtual shopping cart.

According to one aspect of the invention, a border is drawn around the parts which constitute the kit.

According to one aspect of the invention, the metadata includes the part name, part number and price.

According to one aspect of the invention, the ecommerce transaction includes adding a part to an ecommerce shopping cart or virtual shopping cart.

According to one aspect of the invention, the ecommerce transaction includes prompting the user with the option to purchase part(s) associated with the part(s) in the ecommerce shopping cart or virtual shopping cart.

In the aforementioned method, the user may interact with the 3D model using one or more of a pointing device, a menu structure, and a touch sensitive display screen.

In the aforementioned method, the ecommerce transaction is implemented by software running on the server side workstation.

In the aforementioned method, the ecommerce transaction is implemented by software which communicates with at least one of the client side and server side workstations.

In the aforementioned method, the ecommerce transaction is initiated from within the Rendering Engine.

In the aforementioned method, initiating an ecommerce transaction includes transmitting metadata corresponding to the selected part to an ecommerce application.

In the aforementioned method, the user initiates an ecommerce transaction by adding a part to a shopping cart.

In the aforementioned method, the client side workstation communicates with the server side processor over the internet using a web browser.

A variation on the ecommerce method, comprises:

providing a repository of 3D images of a plurality of products, the 3D images including a plurality of views of a given product from a plurality;

rendering engine software executed on one of a client side and server side workstation, the Rendering Engine software accessing the repository of 3D images and causing display of a selected 3D image on the client side workstation;

providing software allowing a user on a client side workstation to search for a selected product whose image is stored in the repository of 3D images and displaying 3D image corresponding to the selected product;

the rendering engine software enabling the user to interact with the displayed 3D image; and

providing ecommerce software communicating with the Rendering Engine software allowing the user to initiate an ecommerce transaction with respect to the parts or subassemblies depicted in the displayed 3D image.

In the aforementioned method, interaction with the 3D image includes the ability to select a different view of the 3D product image.

In the aforementioned method, the different view is selected from the group comprising top, right side, left side, bottom, assembly, subassembly, and exploded.

In the aforementioned method, interaction with the 3D model includes the ability to select an image of the product in one or more stages of decomposition to reveal hidden parts or subassemblies.

In the aforementioned method, selecting or hovering over a rendered 3D image with a pointer of a pointing device triggers the Rendering Engine software to display metadata associated with the part.

In the aforementioned method, selection of a portion of the rendered 3D image triggers the rendering engine to highlight the selected portion of the image.

In the aforementioned method, additional parts related to the selected part are highlighted and the user is prompted to add the additional parts to an ecommerce shopping cart or virtual shopping cart.

In the aforementioned method, if the selected part is available as part of a kit including additional parts then the additional parts are graphically displayed to indicate the availability of a kit and the user is prompted to add the kit to the ecommerce shopping cart or virtual shopping cart.

In the aforementioned method, a border is drawn around the parts which constitute the kit.

In the aforementioned method, the metadata includes the part name, part number and price.

In the aforementioned method, the ecommerce transaction includes adding a part to an ecommerce shopping cart or virtual shopping cart.

In the aforementioned method, the ecommerce transaction includes prompting the user with the option to purchase part(s) associated with the part(s) in the ecommerce shopping cart or virtual shopping cart.

In the aforementioned method, the user interacts with the Rendering Engine using one or more of a pointing device, a menu structure, and a touch sensitive display screen.

In the aforementioned method, the ecommerce transaction is implemented by software running on the server side workstation.

In the aforementioned method, the ecommerce transaction is implemented by software which communicates with at least one of the client side and server side workstations.

In the aforementioned method, the ecommerce transaction is initiated from within the Rendering Engine.

In the aforementioned method, initiating an ecommerce transaction includes transmitting metadata corresponding to the selected part to an ecommerce application.

In the aforementioned method, the user initiates an ecommerce transaction by adding a part to an ecommerce shopping cart or virtual shopping cart.

In the aforementioned method, the client side workstation communicates with the server side processor over the internet using a web browser.

The invention further relates to a system, comprising:

a database on a data storage device, the database containing at least one of a plurality of 3D models including parametric data for rendering a 3D image and a plurality of 3D images;

a server side workstation operably connected to the data storage device;

a client side workstation communicating with the server side workstation over a network;

Rendering Engine software executed on one of the client side and server side workstation, the Rendering Engine receiving the at least one of parametric data and 3D images from the storage device and rendering 3D images therefrom on the client side workstation;

the Rendering Engine comprising software selectively rotating and/or decomposing the image to reveal constituent parts of the product in one or more stages of decomposition;

software accessible to the client workstation for querying the database for a product matching search criteria, the querying software returning a list of products matching the search criteria;

in response to an instruction selecting one of the listed products, the querying software instructing the Rendering Engine to cause the rendering of the three dimensional image representing the selected product; and

ecommerce software receiving instructions from the Rendering Engine to add a part corresponding to an ecommerce shopping cart or virtual shopping cart.

The aforementioned system further comprising metadata associated with each product and with each constituent part thereof, the metadata stored in the database.

### BRIEF DESCRIPTION OF THE DRAWINGS

FIG. 1 is a block diagram of the system of the present invention;

FIG. 2 is a block diagram of the present system invention including a user workstation;

FIG. 3 is a 3D rendering (assembly view) of a landing gear assembly mouse-click menu overlay shown in a system according to the present invention;

FIG. 4 illustrates the landing gear assembly of FIG. 3, after the wheel assembly was selected;

FIG. 5 illustrates the landing gear assembly of FIG. 4 after the wheel assembly was decomposed (exploded) into constituent parts;

FIG. 6 illustrates the landing gear assembly of FIG. 5 with a bounding line showing the parts sold together as a kit; and

FIGS. 7A-C is a flow diagram of the system of the present invention.

### DETAILED DESCRIPTION OF THE INVENTION

The present invention is the process, system, and software for implementing the same which allows a user to interact with a rendered three-dimensional (3D) image of a part or assembly, select a single part or set of parts (kit or sub-assembly) or decompose the 3D assembly to its discrete parts, select specific parts or sub-assemblies and add these parts with their associated metadata (description, size, weight, price, part number, etc) to an ecommerce shopping cart or a virtual shopping cart or other ecommerce purchasing application. Hereinafter reference to an ecommerce shopping cart should be understood to also include reference to a virtual shopping cart and reference to a virtual shopping cart should be understood to also include reference to an ecommerce shopping cart. Additionally, the system of the present invention may optionally include logic to proactively suggest additional or secondary parts or items that may be associated with the repair or replacement of the part(s) or assembly selected for purchase. For example, the system may suggest purchasing consumables such as gaskets and seals which are used in conjunction with the user selected part or assembly. The present invention is distinguished from the prior art in that it is the first ecommerce system in which the user interacts only with rendered 3D images.

This process is accomplished by 1) providing a system software including an interactive 3D model for each of a plurality of items to enable a user to interact with a rendered 3D image of the item. The system of the present invention allows the user to decompose the rendered image of the item into its constituent parts or assemblies and then select or drag parts or assemblies into a shopping cart. As will be discussed below in further detail, the “shopping cart” may be part of an order replenishment system (such as a stock reordering system, an electronic resource planning system, or other inventory reordering systems) in which no money is exchanged but parts are ordered from or/to restock inventory. Moreover, in some embodiments, instead of ordering the parts from a distribution center, the parts may be manufactured onsite by sending the part's parametric information to a 3D printer. Preferably, the 3D model enables the user to decompose the item in two or more levels of detail (granularity). 2) For parts that do not require decomposition, a software process is provided allowing an individual to select a rendered 3D image of a part and execute the “3D click to buy” process adding (transferring) metadata associated with the selected part to an e-commerce solution or application.

As used herein metadata is data describing the part including part number, part description, model number, assembly part number, assembly description, size, weight, diameter, stock or catalog number, price, alternative replacement part(s). The metadata may further include information identifying that the part is also available as part of a kit, or include information regarding other parts which the manufacture has indicated should be replaced along with a given part.

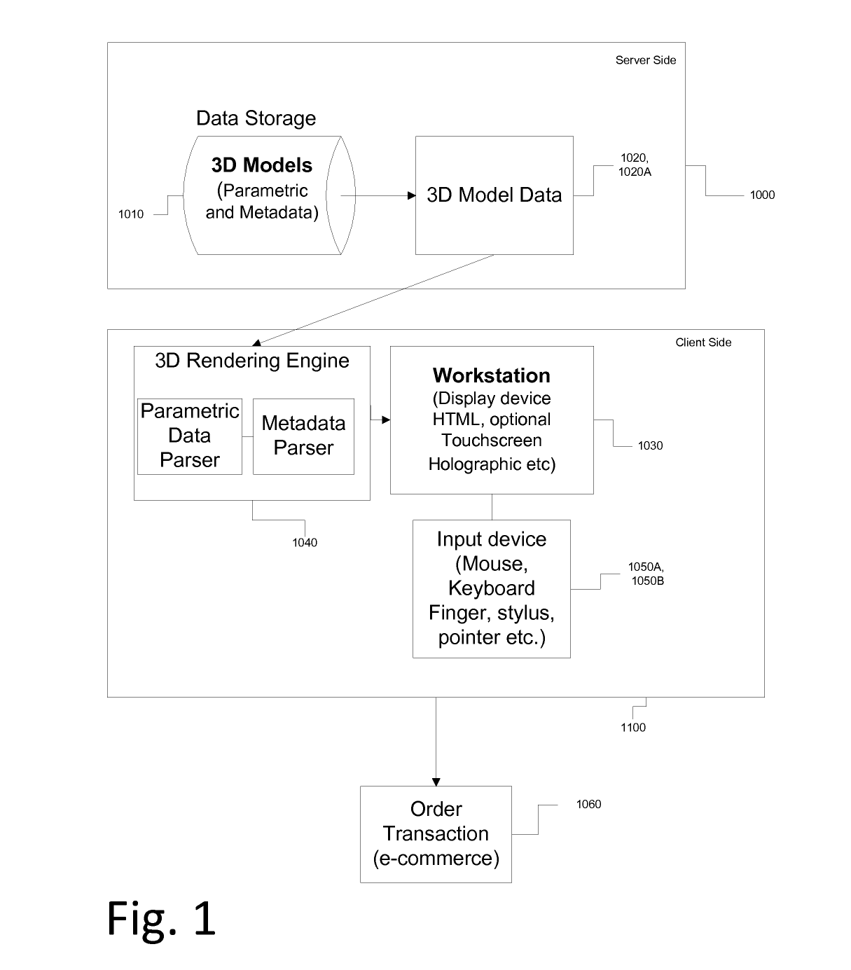

FIG. 1 is a block diagram showing the most basic version of the system of the invention. The System includes a client side 1000 and a server side 1100. The Server Side 1000 includes a storage device 1010 storing one or more interactive 3D models 1020 and any associated parametric data needed to render 3D images. As will be explained below in further detail, in some embodiments, the storage device 1010 stores video images 1020A in place of the interactive 3D models and parametric data. The Client Side 1100 of the System includes a Rendering Engine which receives 3D Model Data 1020 (1020A) and/or Parametric Data from the Server Side 1000. The 3D Rendering Engine includes software and/or hardware for rendering the 3D image on the workstation 1030. Workstation 1030 includes a processor, a display device and software for interacting with the 3D model(s) and rending a 3D image therefrom on the display device. The display device may optionally be a touch sensitive screen enabling the user to interact with the rendered 3D image via the touch sensitive screen. As known in the art, various finger swipe motions may be associated with commands to enlarge the image, rotate the image, explode the image, or select a part or assembly. A keyboard 1050A and pointing device 1050B may also be provided to facilitate interaction with the 3D model.

The server side 1000 is operably connected with the client side 1100 over a network which may be a distributed and/or private network such as a WAN, VPN, or internet.

A user may interact directly with the workstation 1030 and order parts from an order fulfillment center 1060 which communicates with the System over a distributed network (e.g., internet), WAN, VPN or the like.

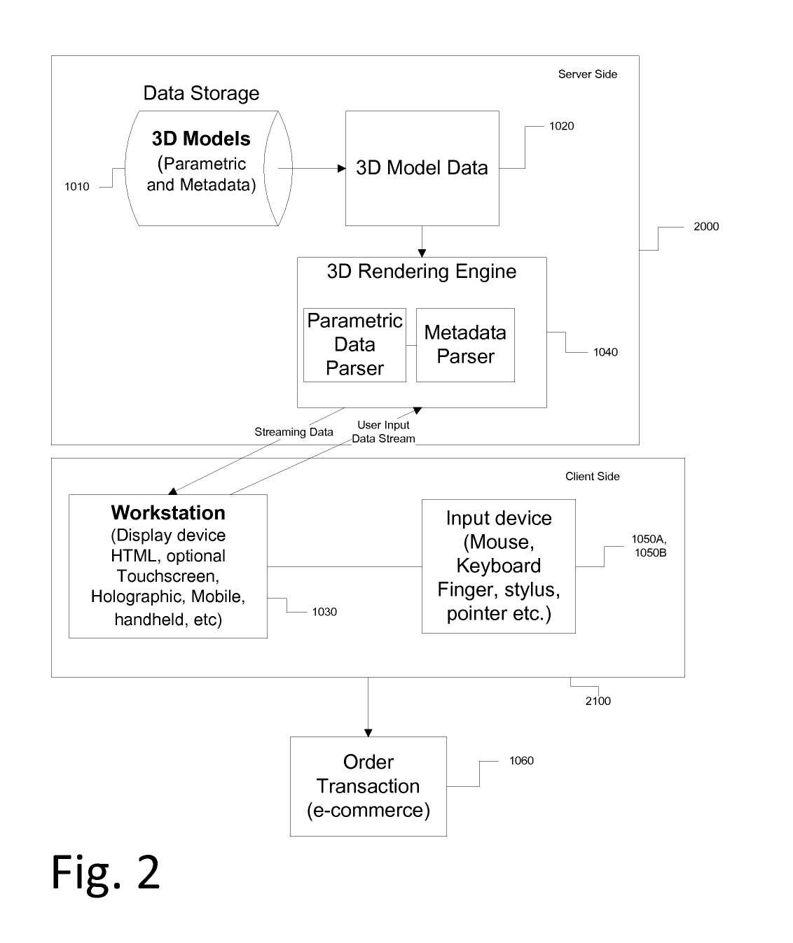

FIG. 2 shows a slight variation of the system of FIG. 1. The difference between FIG. 1 and FIG. 2 is that in FIG. 1 the Rendering Engine 1040 is part of the Client Side 1100 whereas in FIG. 2 Rendering Engine 1040 is part of the Server Side 1000.

Components of the present invention are as follows:

1. Software (Rendering Engine) for rendering a 3D image. The software may include or communicate with an interactive 3D model for rendering a three dimensional image and enabling the image to be rotated about any axis. The software enables the user to decompose to the 3D image in stages to reveal the constituent parts or subassemblies, and allows the user to select a part or parts for purchase. Staged decomposition enables the user to adjust the level of granularity of the assembly. A first level of decomposition could display various subassemblies which may in turn be further decomposed into a further level of sub-assemblies and/or the discrete or constituent parts of the subassembly. The software includes the ability to select a part and add the selected part to a virtual or online shopping cart.

2. Metadata associated to each part of the rendered 3D image describing the part, its weight, size, price, manufacture, part number, etc.

3. E-commerce software executed within or communicating with the aforementioned software enabled interactive 3D model. The user indicates a desire to initiate an e-commerce transaction for a part by selecting the corresponding 3D part rendering and then adding the part to a virtual shopping cart by dragging the 3D image to the shopping cart, right-clicking on the 3D image with a pointing device, double-clicking on the 3D image or the like. Adding a part to the virtual shopping cart may transfer metadata associated with the part to a separate e-commerce software application.

4. A storage device containing one or more interactive 3D models, parametric data used by the 3D models and metadata associated with the parts and assemblies whose images are rendered by the 3D model;

5. A workstation including a processor accessing the storage device and/or for executing or interacting with the interactive 3D model.

The term workstation as used throughout this disclosure is not intended to be limiting and is intended to refer to any processor capable of executing software commands.

The system of the present invention may include a menu or control panel used to interact with the 3D model. The menu enables the user to choose a desired operation such as rotate the rendered image about an axis, shrink or enlarge the rendered image, decompose the rendered image, or add the part to the virtual shopping cart, etc. As the 3D image is decomposed in stages into its discrete components, the system of the present invention preferably maintains the menu in a stable or fixed position within the display. Once a part is selected and the “3D click-to-buy” function is executed, relevant metadata and/or the parametric data for the selected part or component is transferred into an ecommerce application.

As noted previously, some embodiments of the invention utilize 3D images rather than a 3D model. The use of a 3D model is advantageous over the use of 3D images as a model is typically more compact than a series of 3D images. The use 3D images (as opposed to a model which renders 3D images) for a given requires the storage of an image for each of a plurality of different views (perspectives). Thus the system might include a top view, side view, and 3 different levels of decomposition requiring the storage of numerous 3D images.

These 3D images may reside as stand-alone images on a website (HTML or similar), or as embedded components within document software such as Microsoft Word, Microsoft Publisher, Microsoft Excel or Adobe Acrobat .pdf files.

3D Definition: of having or relating to three-dimensional space simulating the effect of depth by presenting parametric data in way that is lifelike or real (having mathematical volume) including presenting slightly different views of a scene to each eye. An object that has height, width and depth unlike a photograph (for example: jpg, .tiff, bmp, or .png file formatted picture) of a 3D dimensional object.

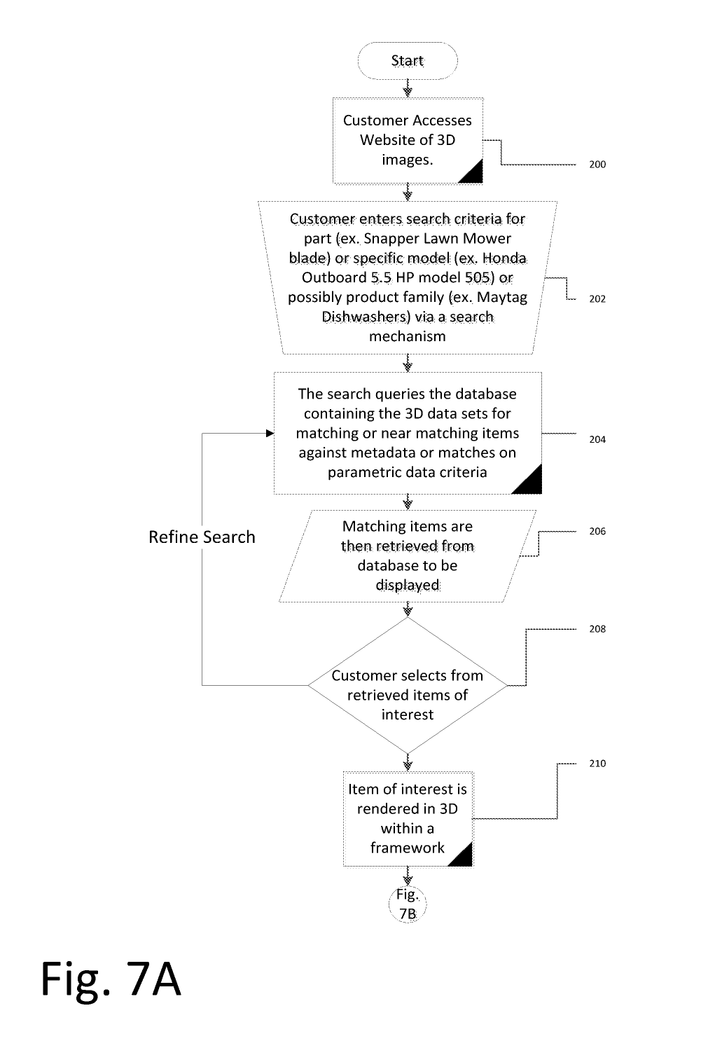

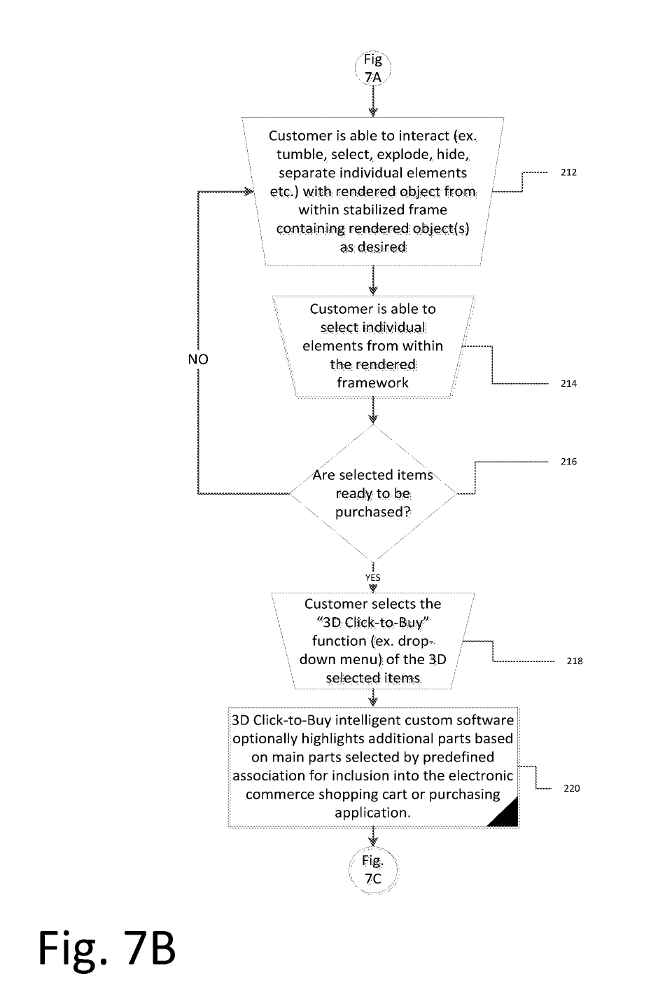

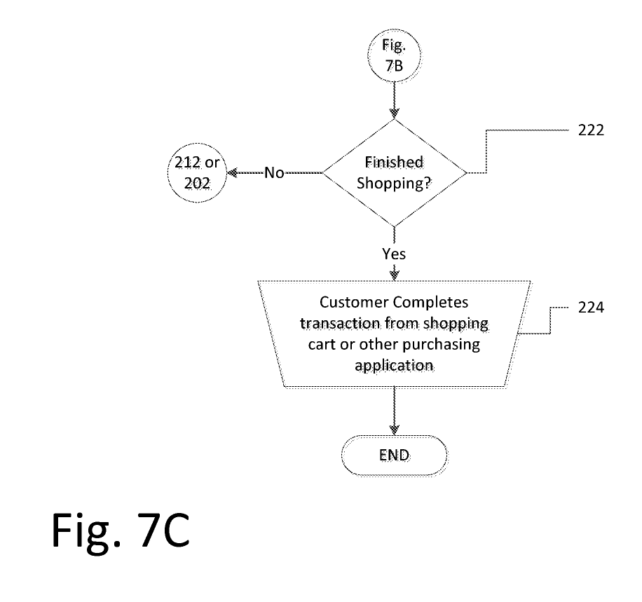

Use of the system of the invention will be further explained with reference to the flow diagram of FIGS. 7A-7C.

In step 200 (FIG. 7A) the user accesses a website or web portal which may be hosted on, or in the alternative communicates with, the Server Side 1000, 2000.

In step 202 (FIG. 7A) the user enters search criteria for an item into the website and initiates a search;

In step 204 (FIG. 7A) the search queries a database 1010 accessible to the website;

In step 206 (FIG. 7A) the website displays the results of the query.

In step 208 (FIG. 7A) the customer selects an item from the displayed results, or loops back to step 204 to refine the search criteria.

In step 210 (FIG. 7A) a 3D rendering of the selected item is displayed on the Client Side display.

In step 212 (FIG. 7B) the user is able to interact with the 3D model. Namely, the user is able to rotate the rendered 3D image about any axis, enlarge the image, and decompose the image into one or more levels of sub-assemblies until the item is decomposed to its constituent parts. The user is able to rotate the rendered 3D image about any of the coordinate axis (X, Y, and Z) and optionally may be provided with the ability to rotate about a user-specified axis.

In step 214 (FIG. 7B) the user is able to select one or more individual parts or subassemblies for purchase, order for inventory replenishment, or send to a 3D printing device or the like, and in steps 216 and 218 the user is able to initiate the purchase of the items selected in the previous step. It should be noted that selection of a part is reflected graphically by changing the color or shading or the like of the selected part within the rendered 3D image.

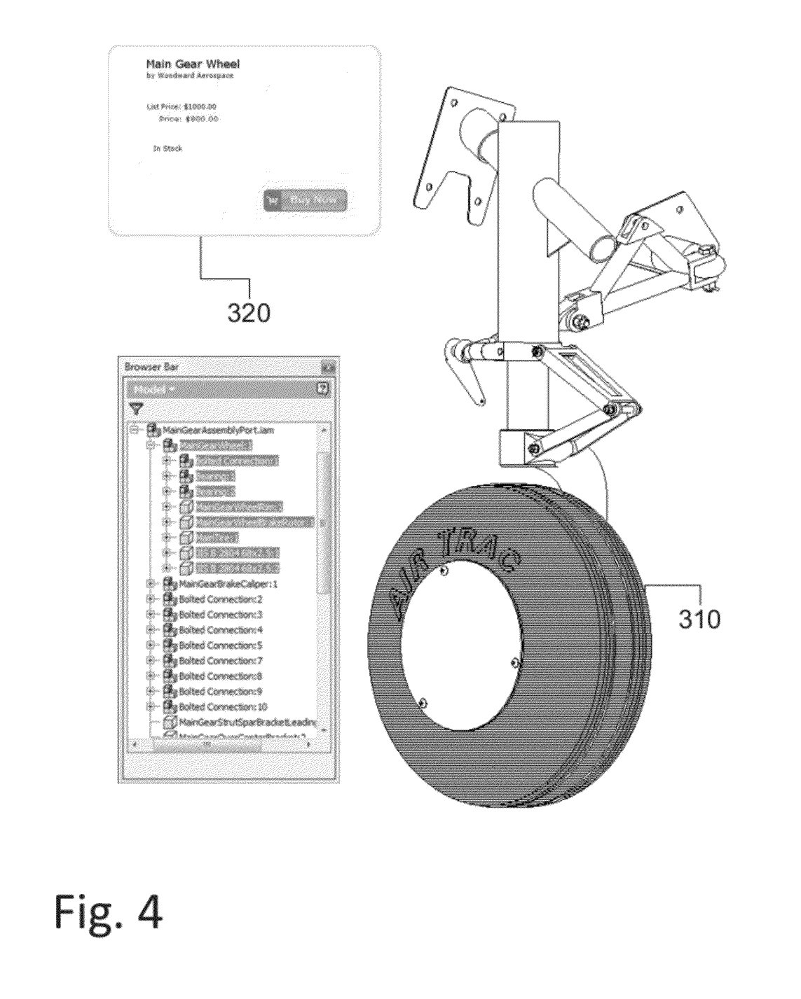

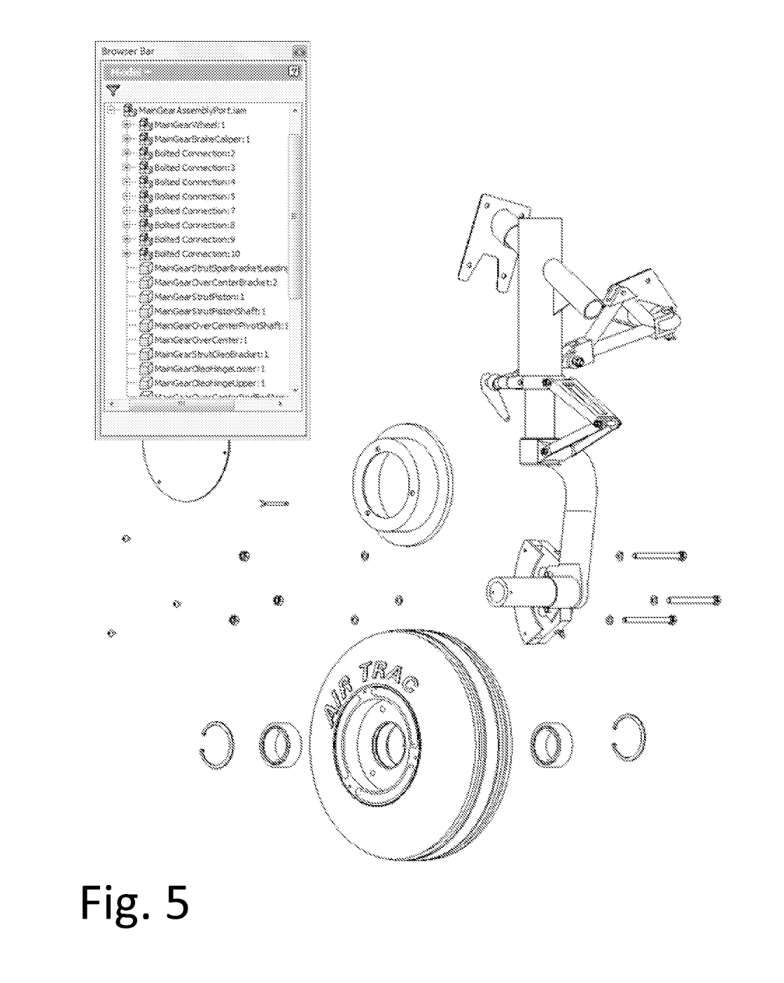

Additionally, the selection of a part triggers the display of metadata associated with the part. In FIG. 4, metadata 330 is displayed when the user selects or hovers over the wheel 310 with the pointer of the pointing device. When a part is selected the system may alert the user that the selected part is also available as part of a kit. This may be accomplished through text on the display, through highlighting, shading or coloring the constituent parts of the kit, and/or by drawing a border around the parts of the kit, or the like. In addition, the display of metadata may optionally be triggered by hovering over a portion of the rendered 3D image with a pointer of a pointing device or the like, i.e., without actually selecting the part.

Purchase of a part is initiated by, for example, right-clicking on the rendered 3D image of desired part and adding the part to the virtual shopping cart, or simply by dragging the part to the virtual shopping cart (step 218). As noted previously, the system of the invention may be part of an internal parts management system in which parts are ordered to restock inventory (i.e., not an actual purchase). In such instances adding the part to the shopping cart merely orders the parts to be restocked. Moreover, the parts may be manufactured on-site by sending the parametric data associated with the part to a 3D printing device or the like. In such instances, the user may or may not need to purchase the part before sending the parametric information to the 3D printer.

In step 220 the system recommends additional parts associated with the part(s) selected by the user. These additional parts may include consumables such as seals, gaskets, springs which are used in conjunction with replacement of the item(s) already selected for purchase. The system may further list items which others have purchased in conjunction with the selected item(s). It should be noted that step 220 is shown as following step 218; however, the specific placement of this step may be moved to, for example, follow step 214.

In steps 222 and 224 (FIG. 7C) the user initiates the checkout/payment processes, continues to manipulate the object in step 212 (FIG. 7B), or starts a new search in step 202 (FIG. 7A).

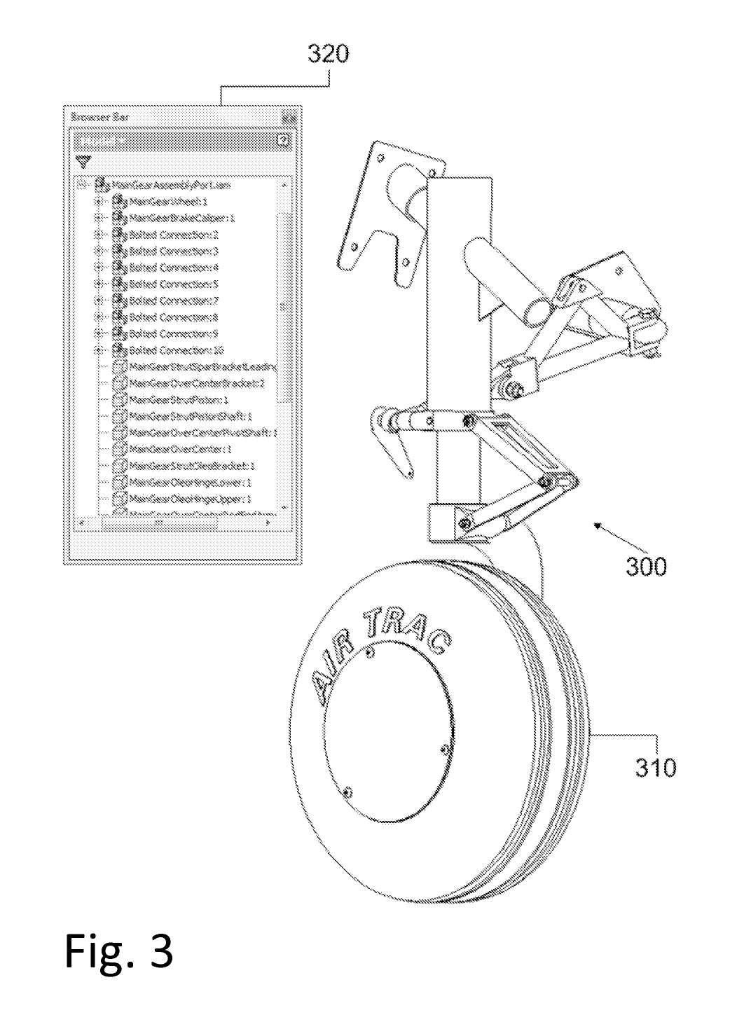

In FIG. 3, a 3D rendering of landing gear 300 components is shown with an optional drop down menu 320. The user is able to interact with the 3D model using a pointing device 1050A, touch sensitive screen 1040A, or via a keyboard 1050B or the like. Interaction with the 3D model includes the ability to rotate the 3D image about any axis, decompose or explode the object into subassemblies and/or discrete constituent parts.

FIG. 4 shows the landing gear components of FIG. 3 after the user selected or hovered (with the pointer or cursor of the pointing device) over the wheel assembly 310. FIG. 4 illustrates how selection or hovering over of a part triggers the display of metadata 330 related to the selected part. The metadata 330 typically includes the part name, part number, and cost. However, the metadata may also indicate that the selected part is part of a kit of a subassembly where as kit is a collection of related parts which the manufacturer recommends being replaced contemporaneously (along with the selected part). The term kit is distinguished from a subassembly in that a subassembly connotes parts which are assembled or connected whereas a kit intended to connote that the parts are not assembled.

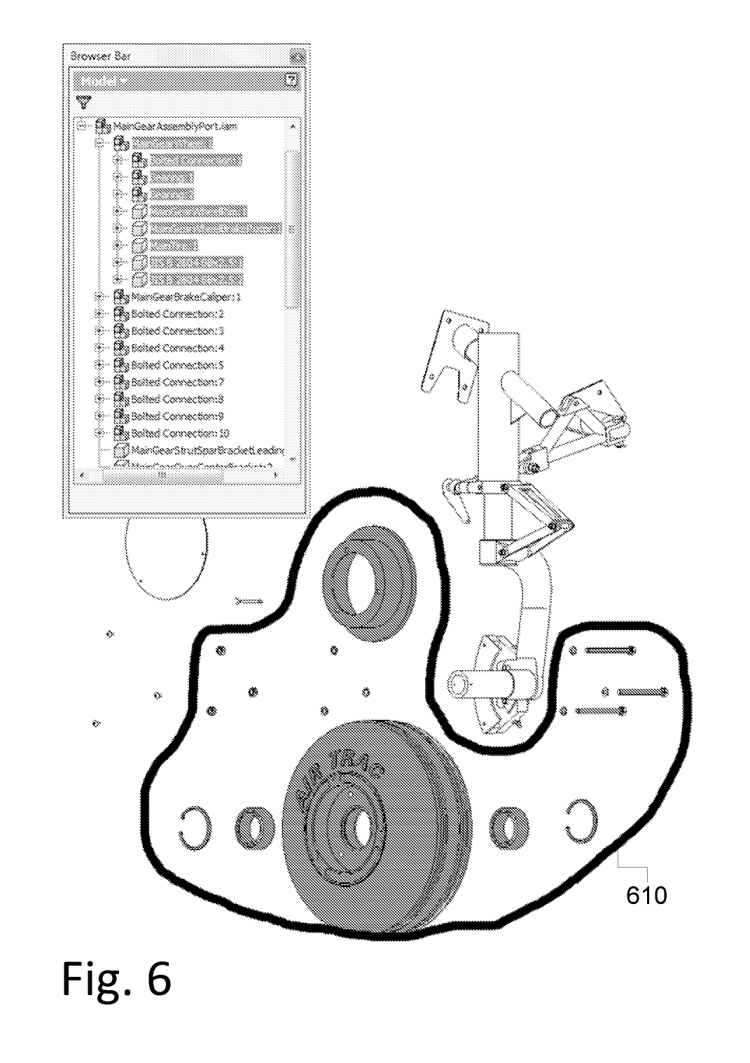

Optionally, the system of the present invention may graphically illustrate the relationship of the selected part to the other parts which collectively form the kit or subassembly. For example, the system may draw a border 610 encompassing all of the parts of a kit (FIG. 6), or the system may denote the constituent parts of a given kit or subassembly using color, shading or the like.

FIG. 5 shows an exploded view of the landing gear components of FIG. 4. Metadata associated with the part including the description, price, weight, size, part number, etc, may also transferred to shopping cart, as needed. “3D click-to-buy” system allows for finite decomposition of assembly to individual parts and selection of these parts. 3D click-to-buy includes logic or processes for recommending additional parts required for replacement of the selected part. In addition, the system may also include a list of other items which purchasers of the selected item frequently purchase.

Four dimensional (4D) images represent 3D-images with the addition of time as the 4th dimension can be applied to create animations or sequences of individual frames of 3D data. The process and ability for the “3D-click-to-buy” custom software to pass the required and necessary parametric and/or metadata data from the selected 4D-image actually comprises of an individual frame in the time sequence of 3D-image data and therefore it is possible to execute a “3D-click-to-buy” from within the 4D sequence. This individual frame in the 4D sequence contains all of the 3D information necessary to execute the decomposing of the image and by relation contains all of the parametric and metadata for each component assembly or sub-assembly. At any point the user can select from the images and complete the process of buying the items in whole or in part.

In another embodiment of the invention, the parametric data or metadata necessary for rendering any of the 3D images can be sent over a TV broadcast signal (See, U.S. Pat. No. 7,661,121 which is incorporated herein by reference thereto) similar to that of the Closed Captioning (U.S. Pat. Nos. 7,889,964, 5,327,176 and, 6,215,526 each of which are incorporated herein by reference thereto) with an on-screen display processor. A toggle is provided to either display or not-display the data stream. When the toggle is active the relevant parametric model data is rendered and subsequently displayed to the user. The user is made aware of the data streams, and subsequent models, through a notification (similar to the Closed Captioning overlaid broadcast logo) at the start of the broadcast. Alternatively if the toggle is enabled then any relevant rendered data is presented over the broadcast signal. Users have the option of selecting the rendered data directly from the broadcast signal or are presented with a separate rendered model that has been separated from the broadcast.

Although the foregoing invention has been described in some detail by way of illustration and example, for purposes of clarity of understanding, it will be obvious that various alternatives, modifications and equivalents may be used and the above description should not be taken as limiting in scope of the invention which is defined by the appended claims.

What is claimed is:

1. An e-commerce method, comprising:
providing a plurality of interactive 3D models in a data storage device, at least one said 3D model for each of a plurality of products, said 3D models including parametric data for rendering a 3D image of a selected said product;
providing Rendering Engine software receiving parametric data from said 3D models and rendering a 3D image on a display on a client side workstation, said Rendering Engine software executing on one of a client side and a server side workstation;
providing software enabling a user on a client side workstation to specify search criteria for searching for a selected product among the plurality of products whose 3D model is stored on the data storage device, said search software returning a list of products matching the search criteria and prompting the user to select one said product
rendering a 3D image of the product using the selected said 3D model;
said rendering engine software prompting the user to interact with the 3D model; and
providing ecommerce software communicating with said Rendering Engine software allowing the user to initiate an ecommerce transaction with respect to the parts or subassemblies depicted in the rendered 3D image.

2. The method of claim 1, wherein interaction with the 3D model includes the ability to rotate the rendered 3D product image about the X, Y, and Z coordinate axis.

3. The method of claim 1, wherein interaction with the 3D model includes the ability to rotate the product image about a user-specified axis.

4. The method of claim 1, wherein the interaction with the 3D model includes the ability to decompose the rendered 3D image of the product in one or more stages to reveal hidden parts or subassemblies.

5. The method of claim 1, wherein selecting or hovering over a rendered 3D image with a pointer of a pointing device triggers the Rendering Engine software to display metadata associated with the part.

6. The method of claim of claim 5, wherein selection of a portion of the rendered 3D image triggers the rendering engine to highlight the selected portion of the image.

7. The method of claim 6, wherein additional parts related to the selected part are highlighted and the user is prompted to add the additional parts to a virtual shopping cart, a electronic parts replenishment system, or 3D printing device.

8. The method of claim 6, wherein if the selected part is available as part of a kit including additional parts then the additional parts are graphically displayed to indicate the availability of a kit and the user is prompted to add the kit to the virtual shopping cart, an electronic parts replenishment system or send to a 3D printing device.

9. The method of claim 8, wherein a border is drawn around the parts which constitute the kit.

10. The method of claim 5, wherein the metadata includes the part name, part number and price.

11. The method of claim 1, wherein the ecommerce transaction includes adding a part to an ecommerce shopping cart, ordering the part from an electronic parts replenishment system, or sending parametric data associated with the part a 3D printing device.

12. The method of claim 11, wherein the ecommerce transaction includes prompting the user with the option to purchase part(s) associated with the part(s) in the virtual shopping cart.

13. The method of claim 1, wherein the user interacts with the 3D model using one or more of a pointing device, a menu structure, and a touch sensitive display screen.

14. The method of claim 1, wherein the ecommerce transaction is implemented by software running on the server side workstation.

15. The method of claim 1, wherein the ecommerce transaction is implemented by software which communicates with at least one of the client side and server side workstations.

16. The method of claim 1 wherein the ecommerce transaction is initiated from within the Rendering Engine.

17. The method of claim 1 wherein initiating an ecommerce transaction includes transmitting metadata corresponding to the selected part to an ecommerce application or 3D printing device.

18. The method of claim 1, wherein the user initiates an ecommerce transaction by adding a part to a virtual shopping cart.

19. The method of claim 1 wherein the client side workstation communicates with the server side processor over the internet using a web browser.

20. An e-commerce method, comprising:
providing a repository of 3D images of a plurality of products, said 3D images including a plurality of views of a given product from a plurality;
rendering engine software executed on one of a client side and server side workstation, said Rendering Engine software accessing said repository of 3D images and causing display of a selected 3D image on the client side workstation;
providing software allowing a user on a client side workstation to search for a selected product whose image is stored in the repository of 3D images and displaying 3D image corresponding to the selected product;
said rendering engine software enabling the user to interact with the displayed 3D image; and
providing ecommerce software communicating with said Rendering Engine software allowing the user to initiate an ecommerce transaction with respect to the parts or subassemblies depicted in the displayed 3D image.

21. The method of claim 20, wherein interaction with the 3D image includes the ability to select a different view of the 3D product image.

22. The method of claim 20, wherein the different view is selected from the group comprising top, right side, left side, bottom, assembly, subassembly, and exploded.

23. The method of claim 20, wherein the interaction with the 3D model includes the ability to select an image of the product in one or more stages of decomposition to reveal hidden parts or subassemblies.

24. The method of claim 20, wherein selecting or hovering over a rendered 3D image with a pointer of a pointing device triggers the Rendering Engine software to display metadata associated with the part.

25. The method of claim of claim 24, wherein selection of a portion of the rendered 3D image triggers the rendering engine to highlight the selected portion of the image.

26. The method of claim 25, wherein additional parts related to the selected part are highlighted and the user is prompted to add the additional parts to an ecommerce shopping cart, electronic parts replenishment system or send parametric data associated with the additional parts to a 3D printing device.

27. The method of claim 25, wherein if the selected part is available as part of a kit including additional parts then the additional parts are graphically displayed to indicate the availability of a kit and the user is prompted to add the kit to the ecommerce shopping cart, electronic parts replenishment system or 3D printing device.

28. The method of claim 27, wherein a border is drawn around the parts which constitute the kit.

29. The method of claim 24, wherein the metadata includes the part name, part number and price.

30. The method of claim 20, wherein the ecommerce transaction includes adding a part to an ecommerce shopping cart, or ordering parts from an electronic parts replenishment system.

31. The method of claim 30, wherein the ecommerce transaction includes prompting the user with the option to purchase part(s) associated with the part(s) in the virtual shopping cart.

32. The method of claim 20, wherein the user interacts with the Rendering Engine using one or more of a pointing device, a menu structure, and a touch sensitive display screen.

33. The method of claim 20, wherein the ecommerce transaction is implemented by software running on the server side workstation.

34. The method of claim 20, wherein the ecommerce transaction is implemented by software which communicates with at least one of the client side and server side workstations.

35. The method of claim 20, wherein the ecommerce transaction is initiated from within the Rendering Engine.

36. The method of claim 20, wherein initiating an ecommerce transaction includes transmitting metadata corresponding to the selected part to an ecommerce application.

37. The method of claim 20, wherein the user initiates an ecommerce transaction by adding a part to a virtual shopping cart.

38. The method of claim 20 wherein the client side workstation communicates with the server side processor over the internet using a web browser.

39. A system, comprising:
a database on a data storage device, said database containing at least one of a plurality of 3D models including parametric data for rendering a 3D image and a plurality of 3D images;
a server side workstation operably connected to the data storage device;
a client side workstation communicating with the server side workstation over a network;
Rendering Engine software executed on one of the client side and server side workstation, said Rendering Engine receiving said at least one of parametric data and 3D images from said storage device and rendering 3D images therefrom on the client side workstation;
said Rendering Engine comprising software selectively rotating and/or decomposing the image to reveal constituent parts of the product in one or more stages of decomposition;
software accessible to the client workstation for querying the database for a product matching search criteria, said querying software returning a list of products matching the search criteria;
in response to an instruction selecting one of the listed products, said querying software instructing the Rendering Engine to cause the rendering of the three dimensional image representing the selected product;
ecommerce software receiving instructions from said Rendering Engine to add a part corresponding to a virtual shopping cart.

40. The system of claim 39, further comprising metadata associated with each product and with each constituent part thereof, said metadata stored in said database.
